(19) United States
(12) Patent Application Publication
(10) Pub. No.: US 2004/0228576 A1
(43) Pub. Date: Nov. 18, 2004

(54) Method and apparatus for broadband chromatic dispersion slope tuning

(76) Inventors: Scott P. Campbell, Thousand Oaks, CA (US); Zhiling Xu, Sunnyvale, CA (US)

Correspondence Address: Scot A. Reader, P.C., Suite 228, 1320 Pearl Street, Boulder, CO, 80302, US

(21) Appl. No.: 10/799,995

(22) Filed: Mar. 12, 2004

Related U.S. Application Data
(60) Provisional application No. 60/455,448, filed on Mar. 18, 2003.

(51) Int. Cl. G02B 6/26

(52) U.S. Cl. 385/27

(57) ABSTRACT

A method and system for dispersion compensation comprises a dispersion compensator (DC) for receiving a train of chromatically dispersed light pulses over a transmission fiber at multiple operational bandwidths and inducing on the train a compensatory dispersion having an adjustable broadband dispersion slope. In one approach, broadband dispersion slope is tuned using a pair of dispersion compensation blocks (DCBs) and mode hopping. In another approach, broadband dispersion slope is tuned using paired DCBs and symmetric intra-channel slope adjustment with mode mismatch. The DCBs are etalon-based. Slope tuning is induced by etalon tuning performed, by way of example, thermally or using microactuators.

### CROSS REFERENCE TO RELATED APPLICATION(S)

This application claims the benefit of U.S. provisional application No. 60/455,448, filed on Mar. 18, 2003, the contents of which are incorporated herein by reference.

### BACKGROUND OF INVENTION

As more operational bandwidths are being used at higher modulation rates in telecommunication transmission fibers, signal anomalies resulting from the characteristics of such fibers need to be more accurately compensated for. One signal anomaly is chromatic dispersion. In chromatic dispersion, different wavelengths of light travel at different speeds down a transmission fiber, thereby causing light pulses encoded on such wavelengths to smear and merge together. This smearing and merging results in the inability to distinguish neighboring bits in the optical data stream at the end of transmission and, if not corrected, results in bit errors.

A common method to correct chromatic dispersion is to reverse its effects; that is, to pass the smeared and merged data pulses through a material that negates the transmission fiber's chromatic dispersion. This undoing of chromatic dispersion by sending chromatically dispersed light through a material that has the reverse, or negative, amount of chromatic dispersion that the transmission fiber has is called dispersion compensation.

A related signal anomaly arising from the characteristics of transmission fibers is chromatic dispersion slope. The chromatic dispersion induced by transmission fibers is often wavelength-dependent. More particularly, chromatic dispersion typically changes roughly linearly with wavelength over an operational bandwidth, for example, an International Telecommunications Union (ITU) transmission channel, and this chromatic dispersion slope generally persists over multiple operational bandwidths. In other words, a transmission fiber typically has associated with it both an intra-channel, or “in-band”, slope and an inter-channel, or “broadband”, slope.

As with correction of chromatic dispersion, a common method to correct chromatic dispersion slope is to reverse its effects. However, known methods to correct broadband chromatic dispersion slope in particular have proven suboptimal. Known methods have included channel-by-channel approaches applied after wavelength demultiplexing, for example, using fiber Bragg gratings or electronics, and certain planar waveguide approaches. Channel-by-channel approaches have generally been suboptimal because they have required mux/demux overhead. Planar waveguide approaches have generally been unsuitable because they have not been able to provide sufficient flexibility in their wavelength dependent coupling constants to tune effectively across a broad spectral band.

### SUMMARY OF INVENTION

The present invention, in one feature, provides a method and system for broadband (i.e. inter-channel) chromatic dispersion slope tuning using a pair of dispersion compensation blocks (DCBs) and mode hopping. The DCBs are applied in series to a train of chromatically dispersed light pulses received over a transmission fiber on multiple operational bandwidths. The DCBs are arranged to apply a substantially equal and opposite intra-channel dispersion slope at the operational bandwidths, resulting in a net near-zero intra-channel dispersion slope at the operational bandwidths. Moreover, at least one of the DCBs is adjustable to change to a different mode number from the other, resulting in a net non-zero inter-channel dispersion slope across the operational bandwidths.

The present invention, in another feature, provides a method and system for broadband chromatic dispersion slope tuning using paired DCBs and symmetric intra-channel slope adjustment with mode mismatch. The DCBs are applied in series to a train of chromatically dispersed light pulses received over a transmission fiber on multiple operational bandwidths. The DCBs are arranged to apply a substantially equal and opposite intra-channel dispersion slope at the operational bandwidths, resulting in a net near-zero intrachannel dispersion slope at the operational bandwidths, and are arranged to operate on different mode numbers, resulting in a net non-zero inter-channel dispersion slope across the operational bandwidths. Moreover, the DCBs are adjustable to change to a steeper or less steep substantially equal and opposite intrachannel dispersion slope at the operational bandwidths, retaining the net near-zero intra-channel dispersion slope while inducing a steeper or less steep net inter-channel dispersion slope.

Each DCB preferably comprises a group of one or more etalons. The adjustments may be made through, for example, thermal, microactuator-driven, or electric field tuning.

The present invention, in another feature, provides a method and system for dispersion compensation comprising a dispersion compensator (DC) for receiving a train of chromatically dispersed light pulses over a transmission fiber at multiple operational bandwidths and inducing on the train a compensatory dispersion having an adjustable inter-channel dispersion slope. The DC preferably comprises a DCB pair as generally described above.

The present invention, in another feature, provides a method and system for dispersion compensation comprising a first DC for receiving a train of chromatically dispersed light pulses over a transmission fiber on multiple operational bandwidths and inducing on the train a first compensatory dispersion; and a second DC for receiving the train from the first DC and inducing on the train a second compensatory dispersion, wherein the second compensatory dispersion has an adjustable inter-channel dispersion slope. The first DC preferably comprises a dispersion compensating fiber (DCF). The second DC preferably comprises dispersion equalization module (DEM) having a DCB pair as generally described above.

These and other features of the invention will be better understood by reference to the detailed description of the preferred embodiment, taken in conjunction with the drawings which are briefly described below. Of course, the invention is defined by the appended claims.

### BRIEF DESCRIPTION OF THE DRAWINGS

FIG. 1 shows a dispersion compensation system having a DCF and a DEM, serially arranged on an optical path, in a preferred embodiment of the invention;

FIG. 2A shows a thermally tunable etalon operative within a DCB in a preferred embodiment of the invention;

FIG. 2B shows a microactuator tunable etalon operative within a DCB in a preferred embodiment of the invention;

FIGS. 3A through 3C illustrate inter-channel dispersion slope adjustment through mode hopping, and in particular:

FIG. 3A shows the chromatic dispersion profile of a first DCB (CD1), a second DCB (CD2), and the sum thereof (CD SUM) within each channel when the first DCB and second DCB are operative on the same mode (M);

FIG. 3B shows the chromatic dispersion profile of a first DCB (CD1), a second DCB (CD2), and the sum thereof (CD SUM) within each channel when the first DCB is operative on a mode (M−m) and the second DCB is operative on a higher mode (M);

FIG. 3C shows the chromatic dispersion profile of a first DCB (CD1), a second DCB (CD2), and the sum thereof (CD SUM) within each channel when the first DCB is operative on a mode (M+m) and the second DCB is operative on a lower mode (M);

FIGS. 4A through 4C illustrate inter-channel dispersion slope adjustment through symmetric intra-channel dispersion slope adjustment with mode mismatch, and in particular:

FIG. 4A shows the chromatic dispersion profile of a first DCB (CD1), a second DCB (CD2), and the sum thereof (CD SUM) within each channel when the first DCB is operative on a mode (M+m), the second DCB is operative on a lower mode (M), and the intra-channel dispersion slopes of the first and second DCBs are of medium magnitude;

FIG. 4B shows the chromatic dispersion profile of a first DCB (CD1), a second DCB (CD2), and the sum thereof (CD SUM) within each channel when the first DCB is operative on a mode (M+m), the second DCB is operative on a lower mode (M), and the intra-channel dispersion slopes of the first and second DCBs are of large magnitude; and

FIG. 4C shows the chromatic dispersion profile of a first DCB (CD1), a second DCB (CD2), and the sum thereof (CD SUM) within each channel when the first DCB is operative on a mode (M+m), the second DCB is operative on a lower mode (M), and the intrachannel dispersion slopes of the first and second DCBs are of small magnitude.

### DETAILED DESCRIPTION OF THE PREFERRED EMBODIMENT

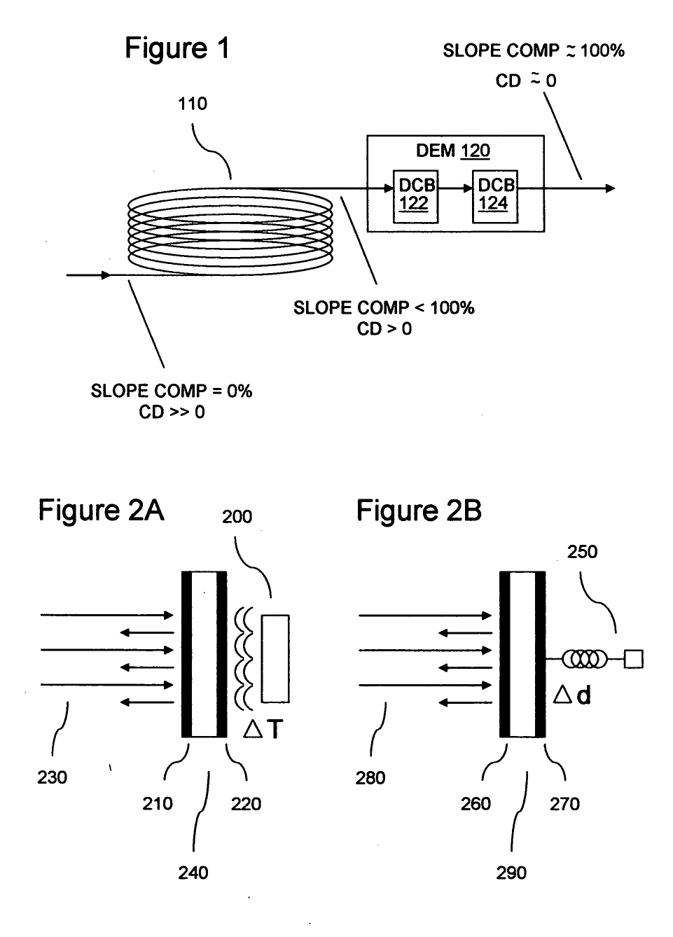

In FIG. 1, a dispersion compensation system having a DCF 110 and a DEM 120, serially arranged along an optical path, is shown. DCF 110 is a dispersion compensating fiber for reversing bulk chromatic dispersion accumulated on light pulses during transmission on a telecommunication transmission fiber. DEM 120 is a dispersion compensator for reversing residual chromatic dispersion and chromatic dispersion slope remaining on the light pulses after application of DCF 110. DEM 120 has a pair of DCBs 122, 124 serially arranged on the optical path. DCBs 122, 124 are Gires-Toumois etalon (GTE) based dispersion compensators each having a group of one or more GTEs. The group of GTEs within each DCB, where the DCB consists of more than one GTE, are also serially arranged along the optical path and provide a group dispersion and a group dispersion slope which are the effective dispersion and dispersion slope, respectively, for the DCB. The group of GTEs within each DCB also operate on group mode number which is the effective mode number for the DCB, although individual GTEs in the DCB may operate on different mode numbers.

In operation, a train of light pulses at multiple operational bandwidths arrives at DCF 110 after transmission on a long haul dense wave division multiplexing (DWDM) transmission fiber with significant chromatic dispersion and a chromatic dispersion slope accumulated during transmission on the fiber. As the train traverses DCF 110, DCF 110 eliminates most of the chromatic dispersion and partially compensates for the chromatic dispersion slope. However, some residual chromatic dispersion and chromatic dispersion slope remain. The train then traverses DEM 120, where the residual chromatic dispersion is reduced to near zero and the chromatic dispersion slope is nearly fully compensated.

At least one of DCBs 122, 124 is tunable to adjust the inter-channel dispersion slope induced by DEM 120 on the train incident from DCF 110. This tuning may be achieved using various techniques alone or in combination. Such techniques include, without limitation, microactuator-driven changes to one or more GTEs within one or more of DCBs 120, 124, or changes to the environment in which one or more GTEs operate induced thermally or through electric field manipulation.

Turning to FIG. 2A, a thermally tunable GTE suitable for application within one of DCBs 122, 124 is shown. The GTE has a first mirror 210 that is partially reflective and a second mirror 220 that is fully reflective light 230 arriving from, for example, DCF 110 enters and exits the GTE through first mirror 210. The GTE subjects different wavelength components of light 230 to variable delay due to its resonant properties. That is, the partial reflectivity of first mirror 210 causes certain wavelength components of light 230 to be restrained in the cavity 240 between first mirror 210 and second mirror 220 longer than others. More particularly, the GTE imposes a wavelength-dependent time delay on the wavelength components of light 230 which, when implemented with other GTEs in its group and its counterpart DCB, reverses the residual inter-channel dispersion slope of light 230.

Thermal tuning is accomplished by selective activation of temperature controller 200, which raises or lowers the temperature of the GTE by a desired number of degrees (ΔT). Raising or lowering the temperature changes the length and the refractive index of cavity 240, thereby inducing a resonance point shift on the GTE. This, in turn, changes the mode number and/or intra-channel dispersion slope of the DCB in which the GTE is operative.

Turning to FIG. 2B, a microactuator tunable GTE suitable for application within one of DCBs 122, 124 is shown. The GTE has a first mirror 260 that is partially reflective and a second mirror 270 that is fully reflective of incident light 280, and the partial reflectivity of first mirror 260 causes certain wavelength components of light 280 to be restrained in the cavity 290 longer than others. Here, however, tuning is accomplished by selective activation of microactuator 250, which moves second mirror 270 horizontally and thereby changes the length of cavity 290 by a desired distance (Δd). Changing the length of cavity 290 induces a resonance point shift on the GTE. This, in turn, changes the mode number and/or the intra-channel dispersion slope of the DCB in which the GTE is operative.

Other tuning methods are possible, such as the introduction of electric field into the environment in which one or more GTEs are operative to induce a change in the refractive index of one or more GTE cavities and a consequent resonance point shift.

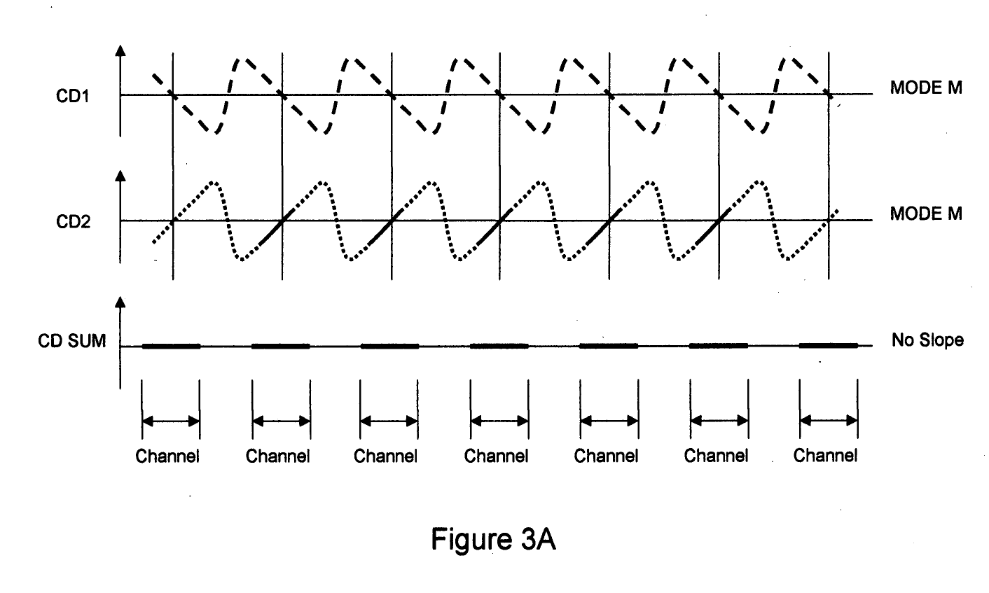

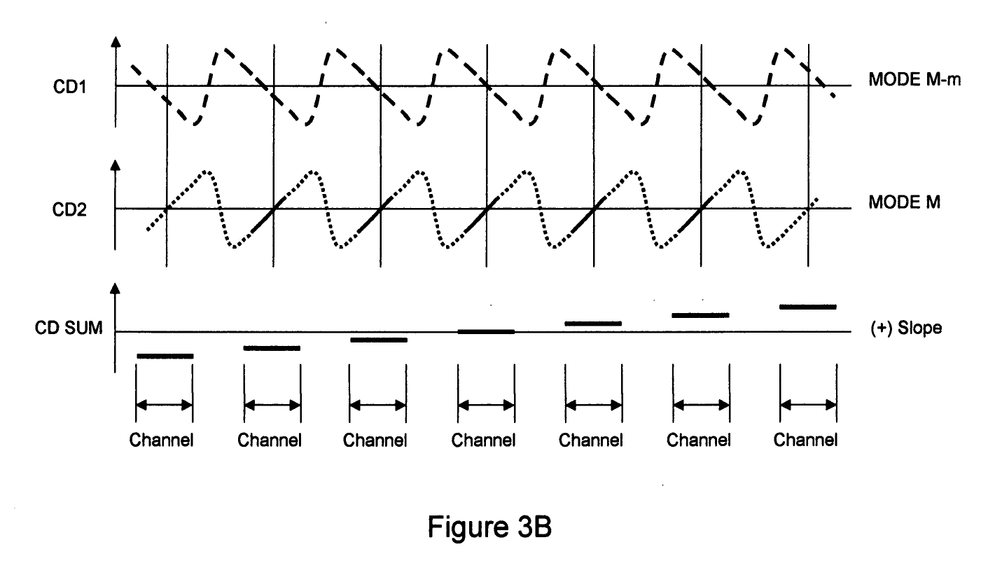

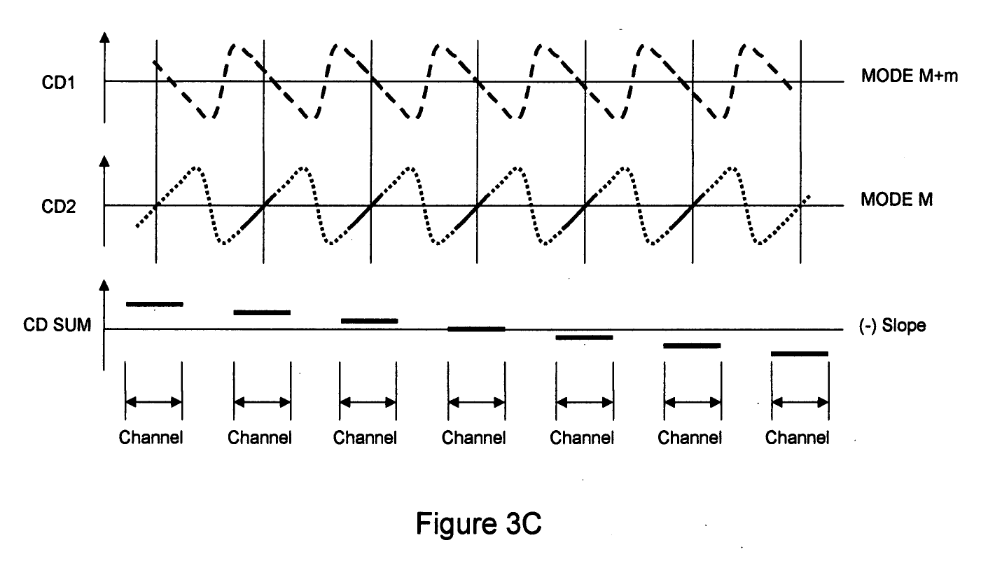

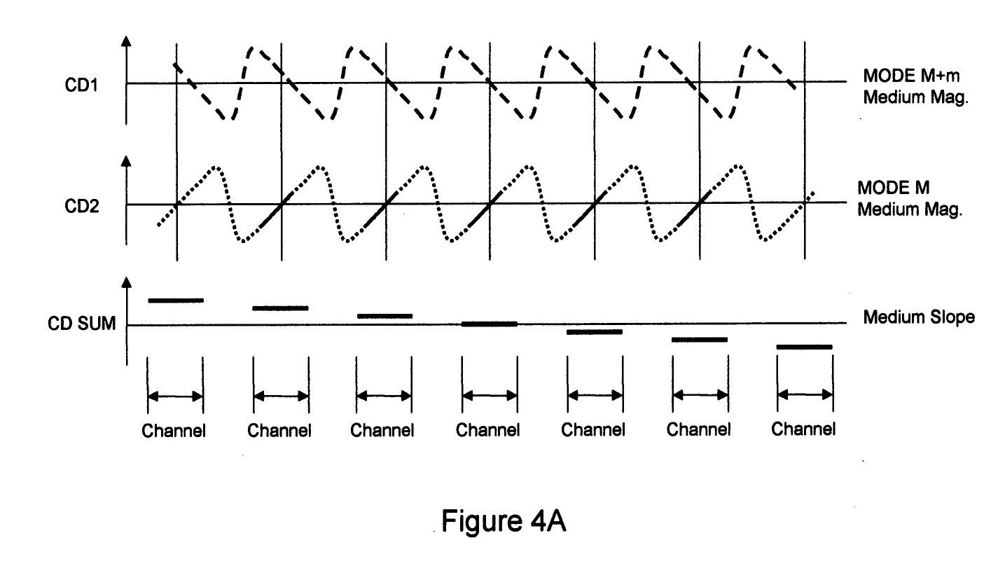

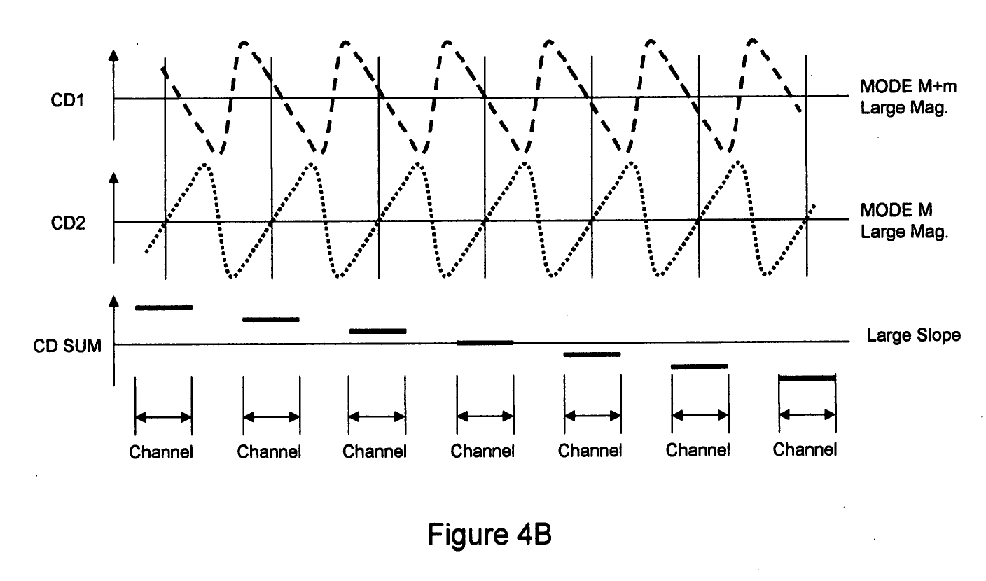

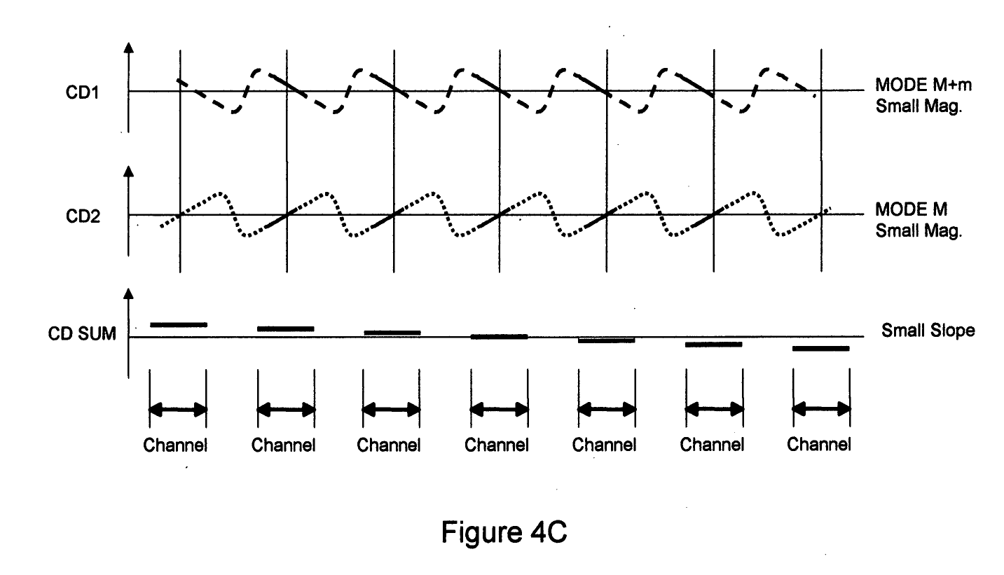

An important aspect of the present invention is to be able to translate changes in the mode number and/or intra-channel dispersion slope induced within Individual ones of DCBs 122, 124 by, for example, thermal, microactuator-based, or electric field tuning, into desired changes in the interchannel dispersion slope of DEM 120. This is accomplished, in a preferred embodiment, through (i) mode hopping or (ii) symmetric intra-channel dispersion slope adjustment with mode mismatch. Mode hopping will be illustrated in a preferred embodiment by reference to FIGS. 3A through 3C. Symmetric intra-channel dispersion slope adjustment with mode mismatch will be illustrated in a preferred embodiment by reference to FIGS. 4A through 4C.

In FIG. 3A, the individual chromatic dispersion profiles of DCB 122 (CD1) and DCB 124 (CD2), and the sum thereof (CD SUM), are shown when the DCB 122 and DCB 124 are operative on the same mode (M). As can be seen, the profiles of DCB 122 and DCB 124 apply a substantially equal and opposite dispersion slope to incident light at each operational bandwidth (i.e. channel), resulting in inducement of a net zero, or substantially zero, intrachannel dispersion slope on each operational bandwidth. Moreover, since the DCB 122 and DCB 124 are operative on a common mode number, the profiles of DCB 122 and DCB 124 also apply a substantially equal and opposite dispersion to incident light at each operational bandwidth, resulting in a net zero, or substantially zero, inter-channel dispersion slope across the operational bandwidths.

In FIG. 3B, the individual chromatic dispersion profiles of DCB 122 (CD1) and DCB 124 (CD2), and the sum thereof (CD SUM), are shown when the DCB 122 and DCB 124 are operative on different mode numbers (M−m and M, respectively). In particular, DCB 122 has been tuned to, i.e. “hopped” to, a lower mode (M−m) such that DCB 122 and DCB 124 share only one resonance point. As can be seen, the profiles of DCB 122 and DCB 124 still induce a substantially equal and opposite dispersion slope on incident light at each operational bandwidth, resulting in inducement of a net zero, or substantially zero, intra-channel dispersion slope at each operational bandwidth. However, since the DCB 122 and DCB 124 are operative on different mode numbers, the profiles of DCB 122 and DCB 124 now induce an opposite but unequal dispersion at each operational bandwidth away from the shared resonance point, resulting in a positive inter-channel dispersion slope across the operational bandwidths.

In FIG. 3C, the individual chromatic dispersion profiles of DCB 122 (CD1) and DCB 124 (CD2), and the sum thereof (CD SUM), are shown when the DCB 122 and DCB 124 are operative on different mode numbers (M+m and M, respectively). In particular, DCB 122 has been tuned to a higher mode (M+m) such that DCB 122 and DCB 124 share only one resonance point. As can be seen, the profiles of DCB 122 and DCB 124 still induce a substantially equal and opposite dispersion slope on incident light at each operational bandwidth, resulting in inducement of a net zero, or substantially zero, intra-channel dispersion slope at each operational bandwidth. However, since the DCB 122 and DCB 124 are operative on different mode numbers, the profiles of DCB 122 and DCB 124 now induce an opposite but unequal dispersion on each operational bandwidth away from the shared resonance point, resulting in a negative inter-channel dispersion slope across the operational bandwidths.

Turning to FIG. 4A, the individual chromatic dispersion profiles of DCB 122 (CD1), DCB 124 (CD2), and the sum thereof (CD SUM), are shown when the DCB 122 is operative on a mode (M+m), the DCB 124 is operative on a lower mode (M), and the intra-channel dispersion slopes of DCBs 122, 124 are of medium magnitude. The situation resembles that shown in FIG. 3C. The profiles of DCB 122 and DCB 124 induce a substantially equal and opposite dispersion slope on incident light at each operational bandwidth, resulting in inducement of a net zero, or substantially zero, intra-channel dispersion slope at each operational bandwidth. However, since the DCB 122 and DCB 124 are operative on different mode numbers, i.e. there is “mode mismatch,” the profiles of DCB 122 and DCB 124 induce an opposite but unequal dispersion on each operational bandwidth away from the shared resonance point, resulting in a negative inter-channel dispersion slope across the operational bandwidths. Moreover, the steepness of the inter-channel dispersion slope may be characterized as medium owing to the medium magnitude of the individual intra-channel dispersion slopes of DCBs 122, 124.

In FIG. 4B, the individual chromatic dispersion profiles of DCB 122 (CD1), DCB 124 (CD2), and the sum thereof (CD SUM), are shown when the DCB 122 is operative on a mode (M+m), the DCB 124 is operative on a lower mode (M), and the intra-channel dispersion slopes of DCBs 122, 124 are of large magnitude. In particular, DCB 122 and DCB 124 have been symmetrically tuned to increase the steepness of their dispersion slopes equally and oppositely. The profiles of DCB 122 and DCB 124 still induce a substantially equal and opposite dispersion slope on incident light at each operational bandwidth, resulting in inducement of a net zero, or substantially zero, intra-channel dispersion slope on each operational bandwidth. However, since the DCB 122 and DCB 124 are operative on different mode numbers, the profiles of DCB 122 and DCB 124 induce an opposite but unequal dispersion at each operational bandwidth away from the shared resonance point, resulting in a negative inter-channel dispersion slope across the operational bandwidths. Moreover, the steepness of the inter-channel dispersion slope may be characterized as large owing to the large magnitude of the individual intra-channel dispersion slopes of DCBs 122, 124.

Finally, in FIG. 4C, the individual chromatic dispersion profiles of DCB 122 (CD1), DCB 124 (CD2), and the sum thereof (CD SUM), are shown when the DCB 122 is operative on a mode (M+m), the DCB 124 is operative on a lower mode (M), and the intra-channel dispersion slopes of DCBs 122, 124 are of small magnitude. In particular, DCB 122 and DCB 124 have been symmetrically tuned to decrease the steepness of their dispersion slopes equally and oppositely. The profiles of DCB 122 and DCB 124 still induce a substantially equal and opposite dispersion slope on incident light at each operational bandwidth, resulting in inducement of a net zero, or substantially zero, intra-channel dispersion slope on each operational bandwidth. However, since the DCB 122 and DCB 124 are operative on different mode numbers, the profiles of DCB 122 and DCB 124 induce an opposite but unequal dispersion at each operational bandwidth away from the shared resonance point, resulting in a negative inter-channel dispersion slope across the operational bandwidths. Moreover, the steepness of the inter-channel dispersion slope may be characterized as small owing to the small magnitude of the individual intra-channel dispersion slopes of DCBs 122, 124.

Although DEM 120 and its constituent DCBs 122, 124 have been described and illustrated as cooperative with DCF 110 within the dispersion compensation system shown in FIG. 1, DEM 120 may operate independently of any other dispersion compensation element. For example, DEM 120 may operate on incident light having zero dispersion and/or zero dispersion slope and generate a positive or negative dispersion and/or dispersion slope on the light “as needed.” It will therefore be appreciated by those of ordinary skill in the art that the invention may be embodied in other specific forms without departing from the spirit or essential character hereof. The present description is therefore considered in all respects to be illustrative and not restrictive. The scope of the invention is indicated by the appended claims, and all changes that come within the meaning and range of equivalents thereof are intended to be embraced therein.

We claim:

1. A method for tuning an inter-channel chromatic dispersion slope of a train of light transmitted on an optical path on a plurality of channels, comprising the steps of:
applying the train of light to a dispersion module on the optical path, the dispersion module having a first dispersion block and a second dispersion block; and while applying the train of light to the dispersion module,
changing a mode number of at least one of the dispersion blocks.

2. The method of claim 1, wherein the dispersion blocks each comprise one or more etalons.

3. The method of claim 1, wherein the changing step is performed using thermal tuning of one or more etalons.

4. The method of claim 1, wherein the changing step is performed using microactuator-driven tuning of one or more etalons.

5. The method of claim 1, wherein the dispersion blocks in combination define an intra-channel chromatic dispersion slope profile, and wherein the changing step does not substantially change the combined intra-channel chromatic dispersion slope profile.

6. A method for tuning an inter-channel chromatic dispersion slope of a train of light transmitted on an optical path on a plurality of channels, comprising the steps of:
applying the train of light to a dispersion module on the optical path, the dispersion module having a first dispersion block and a second dispersion block operative on different mode numbers, the dispersion blocks each having an intra-channel chromatic dispersion slope profile associated therewith; and while applying the train of light to the dispersion module,
symmetrically changing the intra-channel dispersion slope profiles.

7. The method of claim 6, wherein the dispersion blocks each comprise one or more etalons.

8. The method of claim 6, wherein the changing step is performed using thermal tuning of one or more etalons.

9. The method of claim 6, wherein the changing step is performed using microactuator-driven tuning of one or more etalons.

10. The method of claim 6, wherein the dispersion blocks in combination define an intra-channel chromatic dispersion slope profile, and wherein the changing step does not substantially change the combined intra-channel chromatic dispersion slope profile.

11. A method for tuning an inter-channel chromatic dispersion slope of a train of light transmitted on an optical path on a plurality of channels, comprising the steps of:
applying the train of light to a dispersion module on the optical path, the dispersion module having a first inter-channel dispersion slope associated therewith; and while applying the train of light to the dispersion module,
adjusting the dispersion module, wherein the adjusted dispersion module has a second inter-channel dispersion slope associated therewith, and wherein the inter-channel dispersion slopes are substantially different.

12. The method of claim 11, wherein the dispersion module has a first dispersion block and a second dispersion block, and wherein the adjusting step comprises changing a mode number of at least one of the dispersion blocks.

13. The method of claim 12, wherein the first and second dispersion blocks each comprise one or more etalons.

14. The method of claim 11, wherein the dispersion module has a first dispersion block and a second dispersion block each having an intra-channel chromatic dispersion slope profile associated therewith, wherein the dispersion blocks are operative on different mode numbers, and wherein the adjusting step comprises symmetrically changing the intra-channel chromatic dispersion slope profiles.

15. The method of claim 14, wherein the dispersion blocks each comprise one or more etalons.

16. The method of claim 11, wherein the adjusting step is performed using thermal tuning of one or more etalons.

17. The method of claim 11, wherein the adjusting step is performed using microactuator-driven tuning of one or more etalons.

18. The method of claim 11, wherein the dispersion module has a first dispersion block and a second dispersion block, wherein the dispersion blocks in combination define an intra-channel chromatic dispersion slope profile, and wherein the adjusting step does not substantially change the combined intra-channel chromatic dispersion slope profile.

19. A dispersion module for tuning a chromatic dispersion slope of a train of light transmitted on an optical path on a plurality of channels, comprising:
a first dispersion block having a first inter-channel chromatic dispersion profile associated therewith;
a second dispersion block coupled to the first dispersion block along the optical path, the second dispersion block having a second inter-channel chromatic dispersion profile associated therewith, wherein the inter-channel chromatic dispersion profiles in combination define a first inter-channel chromatic dispersion slope; and
adjustment means operative on at least one of the dispersion blocks to change the first inter-channel chromatic dispersion slope into a second inter-channel chromatic dispersion slope.

20. The module of claim 19, wherein the dispersion blocks each comprise one or more etalons.

21. The module of claim 19, wherein the adjustment means comprises a thermal tuner for changing the temperature of one or more etalons.

22. The module of claim 19, wherein the adjustment means comprises a microactuator coupled to one or more etalons.

23. The module of claim 19, wherein the adjustment means changes a mode number of at least one of the dispersion blocks.

24. The module of claim 19, wherein the dispersion blocks each have an intra-channel chromatic dispersion slope profile, wherein the dispersion blocks are operative on different mode numbers, and wherein the adjustment means symmetrically changes the intra-channel chromatic dispersion slope profiles.

25. The module of claim 19, wherein the dispersion blocks in combination define an intra-channel chromatic dispersion slope profile, and wherein the adjusting step does not substantially change the combined intra-channel chromatic dispersion slope profile.
